(19) United States
(12) Patent Application Publication
(10) Pub. No.: US 2026/0237270 A1
(43) Pub. Date: Aug. 13, 2026

(54) SYSTEMS AND METHODS FOR ORGANIZING AND DEPLOYING LONGEVITY-RELATED ELECTRONIC GAMES

(71) Applicants: Walter Bachtiger, Wittenbach (CH); Michael Gitelmaker, Livingston, NJ (US); Bruce Ramsay, Novato, CA (US)

(72) Inventors: Walter Bachtiger, Wittenbach (CH); Michael Gitelmaker, Livingston, NJ (US); Bruce Ramsay, Novato, CA (US)

(73) Assignee: Time Reality Inc., Novato, CA (US)

(21) Appl. No.: 19/180,424

(22) Filed: Apr. 16, 2025

Related U.S. Application Data
(60) Provisional application No. 63/635,193, filed on Apr. 17, 2024.
(60) Provisional application No. 63/678,106, filed on Aug. 1, 2024.
(60) Provisional application No. 63/678,108, filed on Aug. 1, 2024.
(60) Provisional application No. 63/757,622, filed on Feb. 12, 2025.
(60) Provisional application No. 63/780,538, filed on Mar. 31, 2025.

(51) Int. Cl. G07F 17/32; G06Q 30/0207; H04L 9/40

(52) U.S. Cl. CPC G07F 17/3288; G06Q 30/0209; G07F 17/3237; G07F 17/3244; H04L 63/0861

(57) ABSTRACT

An electronic gaming system is disclosed. The system is configured to receive identifying information for each contestant and record within a database each contestant's current age, target age, and a wagered amount. The system is configured to then calculate an award amount that the gaming system will pay to each contestant if, and only if, each such contestant lives until the target age. The award amount is influenced by the target age, an amount of time between the current age and target age, and the wagered amount. The systems may also be operated to generate trusts, master trusts, reinsurance products, and mutual funds-all of which are centered on the disclosed longevity games. The systems may be accessed and utilized through a centralized AgeTech hub, through the different types of users may access and operate the disclosed gaming systems.

### CROSS-REFERENCE TO RELATED APPLICATIONS

This application claims priority to, and incorporates by reference, U.S. provisional patent application 63/635,193, filed on Apr. 17, 2024; provisional patent application 63/678,106, filed on Aug. 1, 2024; U.S. provisional patent application 63/678,108, filed on Aug. 1, 2024; U.S. provisional patent application 63/757,622, filed on Feb. 12, 2025; and U.S. provisional patent application 63/780,538, filed on Mar. 31, 2025, all of which are hereby incorporated herein by reference.

### FIELD OF THE INVENTION

The field of the present invention relates to games of chance. More specifically, the field of the present invention relates to games of chance, implemented through electronic platforms, which involve each participant's lifespan and longevity. In addition, the field of the present invention relates to games of chance having specific focus on those that integrate contestant lifespan and health choices into the gameplay, offering a unique blend of gaming experience and health-conscious engagement, while potentially benefiting a contestant's net worth (mostly at a later point in their life).

### BACKGROUND OF THE INVENTION

Lotteries, legalized sports betting, and other games of chance have grown in popularity over the past several decades. Such games often have multiple aims, such as providing a unique source of entertainment for contestants, sometimes providing a considerable source of funding for States and other organizations that sponsor such games, and, for a lucky few, such games can provide a considerable financial reward. Although a myriad of different lotteries and sport betting platforms exist, the outcomes of such games rarely (if ever) are dependent on the long-term health and longevity status of contestants. Rather, the outcomes of most lotteries and sport betting platforms are completely out of the hands of contestants and, furthermore, are not influenced by a contestant electing to live a healthy lifestyle.

As the following will demonstrate, the systems and methods described herein provide a unique electronically-implemented game of chance that directly involves each contestant's ability to live to a desirable age.

### SUMMARY OF THE INVENTION

According to certain aspects of the present invention, electronic gaming systems are disclosed that directly involve each contestant's ability to live until a desirable age. The gaming systems generally include a server, one or more processors coupled to memory, and a database. The one or more processors are configured to receive, and record within the database, contestant identifying information for each contestant. In addition, the processors are configured to receive and record within the database each contestant's current age, a target age, and a wagered amount. The system is configured to then calculate an award amount that the gaming system will pay to each contestant if, and only if, each such contestant lives until the target age. The award amount is influenced by the target age, an amount of time between the current age and target age, the probability of living to the target age, and the wagered amount. The system is also configured to present the award amount to each contestant; receive each contestant's approval of the award amount and the related conditions; and collect funds from each contestant that represent the wagered amount. The invention further provides that the gaming systems described herein may be organized, implemented, and made available to contestants through databases or blockchain technology and related frameworks.

According to additional aspects of the present invention, the electronic gaming systems are further configured to generate and/or receive an individual trust that is dedicated to each contestant, with such individual trusts including instructions that govern the conditions in which the award amount will be paid to a beneficiary (or multiple beneficiaries) identified in each such individual trust. The invention provides that the system is configured to receive the individual trust for each contestant by uploading such individual trust to the server through an electronic user interface (e.g., such as from a contestant's attorney or directly from the contestant). In other embodiments, the server of the system is configured to generate each individual trust for contestants by receiving input from each contestant through the electronic user interface and, based on such input, automatically generating each individual trust for each of such contestants within the system. In addition, the system may be configured to carry out an identity verification process, which may utilize notaries and/or other identity verification services.

According to such aspects of the present invention, the system may be configured to automatically generate a master trust that is linked to each individual trust that is dedicated to each contestant participating in a particular game. The invention provides that the master trust also includes instructions that govern the conditions in which the award amount will be paid to the beneficiary identified in each such individual trust. Still further, the invention provides that the system may be configured to automatically group contestants into a pool that is assigned to a particular master trust, with the contestants being grouped into the pool based on criteria specified by a game organizer (such as similarities in current ages, target ages, wagered amounts, award amounts, and other criteria). In other embodiments, the pools of contestants may share other bonds, such as pools of contestants of the same immediate family, members of a church or other organizations, etc. The invention provides that the system is configured to encrypt all contents of the individual trusts and master trusts (and the relationships among such trusts)—and, furthermore, to heavily encrypt, disguise, and prevent disclosure of all contestant identifying information associated with such individual trusts and master trusts.

According to certain aspects of the present invention, electronic systems and exchanges are provided that enable life insurance companies to reduce the potential, aggregate liability that such companies hold in relation to the large volume of life insurance policies that such companies issue to customers. More particularly, the systems described herein provide a means for reinsuring against the potential, aggregate liability that life insurance companies hold in relation to such life insurance products.

According to such aspects of the invention, the systems disclosed herein relate to reinsurance products that payout if, and only if, a person who is the subject of a particular reinsurance product survives until a defined target age. Of course, life insurance policies-such as a term 30 life insurance policies-obligate the associated insurance company to payout a defined amount if, and only if, the insured passes away during the contracted 30-year period. If the insured lives for the entire 30-year period, the insurance company is not obligated to pay anything (and the insurance company “wins” in the sense that it collected and retained premiums over the course of that 30-year period).

The invention provides that systems of the present invention can be used to design a reinsurance product (as part of the longevity games described herein) that, in many ways, works in an opposite direction as a conventional life insurance product. More specifically, the systems can be used to design and issue a reinsurance product that obligates the reinsurance company to pay the insurance company if, and only if, the insured individual survives until a defined target age. Thus, in that scenario, the insurance company retains not only the collected premiums for those insureds who live for the 30-year period (e.g., in the case of term 30 life insurance policies), but also the amount collected from the reinsurance company (assuming that same person survived until the agreed upon target date for the reinsurance product).

The invention provides that such additional amounts collected from the reinsurance company can be used to offset amounts paid for other insureds who did pass away during, for example, a contracted 30-year period. In other aspects of this invention, the insurance and reinsurance products may be underwritten and controlled by the same company, such that if an insured passes away during the contracted 30-year period, the insurance product pays out while the reinsurance product does not and essentially retains the premiums paid for the reinsurance product (such that the products effectively offset each other, at least to some extent).

The invention provides that the reinsurance amount may be influenced by the target age, an amount of time between the current age and target age, the amount of the reinsurance premium, and numerous other variables. The system is also configured to present such details to an operator within the insurance company; receive each operator's approval of such details and the related conditions; and collect funds from each insurance company that represents the agreed upon premium or cost for the applicable reinsurance product.

According to yet further aspects of the present invention, a comprehensive “AgeTech” platform is disclosed, which may be accessed, operated, and utilized by the gaming contestants described herein, along with gaming companies (such as casinos wanting to create simple longevity-related games of chance), insurance companies (e.g., to generate the reinsurance products described herein), wealth and financial advisors, mutual funds, and others. In other words, the electronic gaming systems of the present invention may serve as a centralized hub through which individuals may participate in the longevity-related games described herein; insurance companies may generate reinsurance products that apply to such contestants (and/or pools of contestants); financial advisors may create Regulation A compliant (SEC exempt) trusts described herein that become a part of each contestant's long-term financial planning; and mutual funds may create packages of bundled master trusts that operate, in part, as SEC-compliant mutual funds (e.g., the pool of gaming contestants and corresponding trusts described herein); etc. The invention provides that the gaming system can be tailored and operated by each of those types of users, to achieve each user's specific and unique goals.

According to additional aspects of the present invention, methods for establishing, organizing, deploying, and managing electronic gaming systems in the field of long-term health and longevity are provided, which generally entail the operation of the systems described herein.

The above-mentioned and additional features of the present invention are further illustrated in the Detailed Description contained herein.

### BRIEF DESCRIPTION OF THE DRAWINGS

FIG. 1 is a diagram of the various components of the electronic gaming systems described herein.

FIG. 2 is a diagram showing the relationship of each contestant's current age, target age, and award amount.

FIG. 3 is a diagram showing the relationship of each contestant's current age, target age, and award amount—with contestants who do not survive until the target date being paid and refunded the wagered amount.

FIG. 4 is a diagram of a user interface of the electronic gaming systems through which a contestant may specify and modulate his/her current age, target age, and wagered amount.

FIG. 5 is a diagram of the game management console of the electronic gaming systems described herein.

FIG. 6 is a diagram showing the electronic gaming system's ability to generate and utilize a series of trust instruments assigned to each game contestant, with each of such trusts being linked to a master trust (Trust M) that is dedicated to a specific game and pool of contestants.

FIG. 7 is a diagram showing the relationship among a series of trust instruments assigned to each game contestant (T1-T5), which are linked to a master trust (Trust M) that is dedicated to a specific game and pool of contestants. In this arrangement, the master trust (Trust M) is designed to receive and pool funds from each contestant's individual trust and, upon reaching the target age, issue award amounts back to each surviving contestant's original trust that is dedicated to such contestant.

FIG. 8 is a diagram showing the relationship among a series of trust instruments assigned to each game contestant (T1-T5), which are linked to a master trust (Trust M) that is dedicated to a specific game and pool of contestants. In this arrangement, the master trust (Trust M) is designed to receive and pool funds from each contestant's individual trust and, upon reaching the target age, issue award amounts back to each surviving contestant through a second dedicated trust (T1B and T5B) that is established for each such contestant.

FIG. 9 is a diagram showing the electronic gaming system's ability to receive a trust that is dedicated to a specific contestant from an external attorney; receive a trust that dedicated to a specific contestant directly from the contestant; and generate a trust within the system based on input provided by a contestant.

FIG. 10 is a diagram showing the electronic gaming system's ability to allow contestants to specify how wagered amounts will be invested by the game organizer.

FIG. 11 is a diagram showing the electronic gaming system's ability to group contestants into dedicated pools/games based on various criteria, such as shared or similar current ages, target ages, preferred investment products, and other criteria used to match and pool contestants.

FIG. 12 is a diagram that provides a simplified summary of the quantum of payout risk associated with a basic term 30 life insurance policy and the reinsurance products described herein, as a function of the passage of time and the insured subject's age.

FIG. 13 is a diagram showing the relationship of each insured subject's current age, target age, the reinsurance premiums paid, and the associated reinsurance amount.

FIG. 14 is a set of diagrams that illustrates the interaction of obligated payouts between the insurance company and reinsurance company described herein.

FIG. 15 is a diagram that illustrates the flow of aggregated funds among insureds, insurance companies, and reinsurance companies that utilize the systems described herein.

FIG. 16 is a diagram of a simplified version of a reinsurance management console described herein.

FIG. 17 is a diagram showing the relationship of the wagered amount pool and the survivor pool described herein.

FIG. 18 is another diagram showing the relationship of the wagered amount pool and the survivor pool described herein.

FIG. 19 is a diagram of the centralized AgeTech platform described herein.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used, and made without departing from the scope and spirit of the invention.

### Longevity Electronic Gaming System

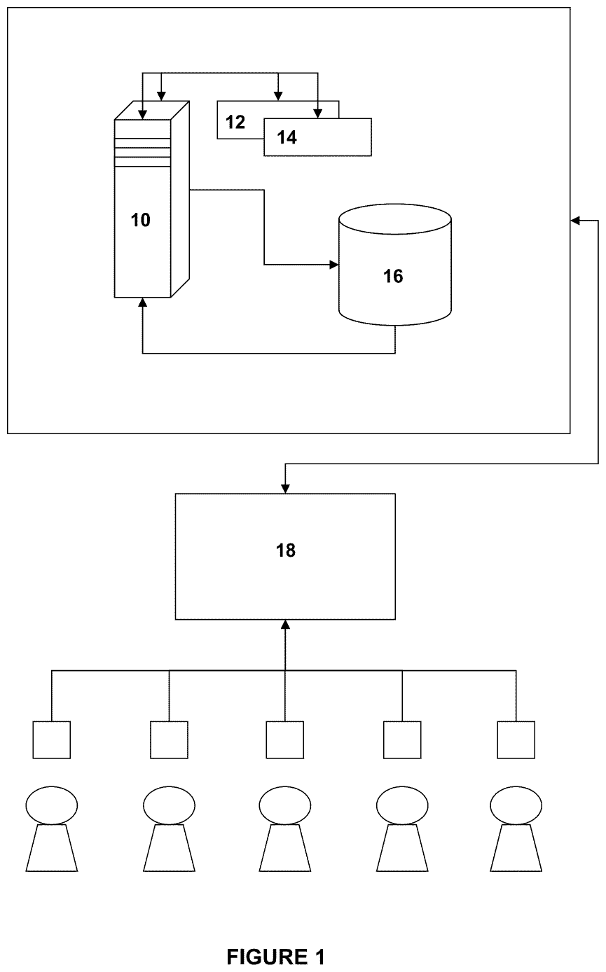

Referring now to FIGS. 1-5, according to certain preferred embodiments of the present invention, electronic gaming systems are disclosed that directly involve each contestant's ability to live until a desirable age. The gaming systems generally include at least one server 10, one or more processors 12 coupled to memory 14, and a database 16, all operably networked with each other. The one or more processors 12 are configured to receive, and record within the database 16, contestant identifying information for each game contestant. The invention provides that such contestant information may include each contestant's full name, address, username, and other unique identifying information, such as each contestant's social security number and/or other personal identifiers. In certain preferred embodiments, the processor 12 is further configured to authenticate the identity of each contestant based on each contestant's identifying information. More particularly, the invention may be configured to carry out and possibly automate identity verification functions, such as through the use of biometric data, notary processes, and/or through analysis of government-issued IDs. In addition to (or as an alternative to) dedicated servers 10, processors 12, and databases 16, the invention further provides that the gaming systems of the present invention may be organized, implemented, and made available to contestants through blockchain technology and related electronic frameworks.

According to such preferred embodiments, the invention provides that the processors 12 are configured to also receive and record within the database 16 each contestant's current age, a target age, and a wagered amount. The invention provides that the gaming system may further include means for verifying the current age submitted by each contestant. The invention provides that a contestant's “current age” is defined and set as the age of a contestant on the date on which such contestant decides to place a wager and take part in the game. The “target age” is preferably defined and set by each contestant, which represents the age that each contestant is betting that he/she will be able to achieve (i.e., that he/she will be able to survive until the target age). The “wagered amount” represents an amount of money that each contestant agrees to submit in exchange for playing the game. The invention provides that each contestant's identifying information, current age, target age, and wagered amount will be electronically transmitted to the system through an electronic user interface 18. The electronic user interface 18 may consist of, for example, desktop computers, tablets, phones, and other devices that are capable of establishing a communication link with the server 10 (or blockchain framework) of the gaming system.

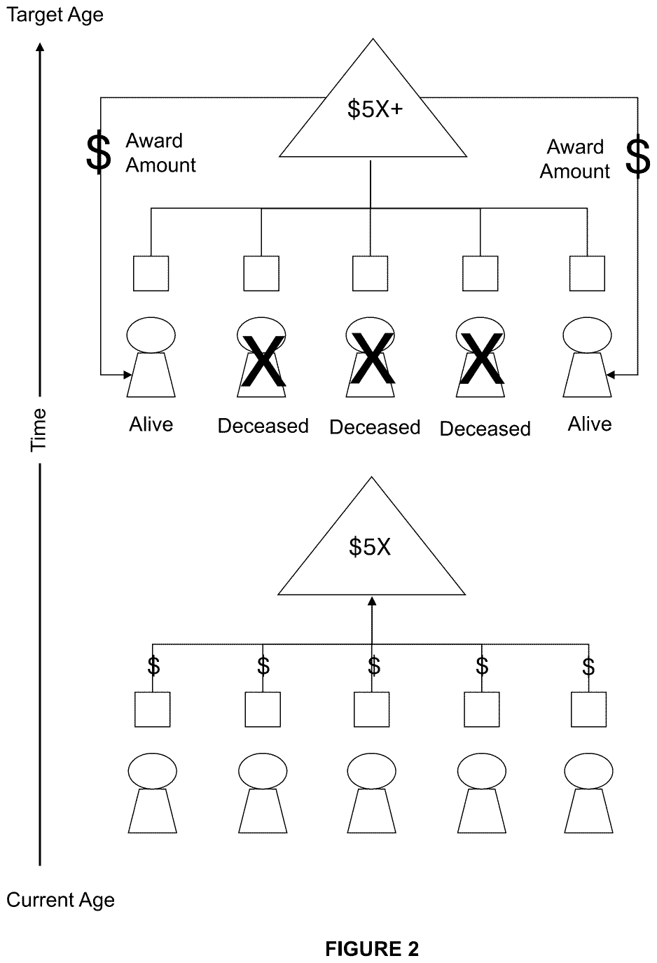

According to such preferred embodiments, the gaming system is configured to then calculate an award amount that the gaming system will pay to each contestant if, and only if, each such contestant lives until the target age. As illustrated in FIG. 2, for example, if five contestants enter and participate in the game and specify each of their current age, target age, and wagered amounts, at the time of each contestant's specified target age, some contestants will have survived and achieved their target age, while others will have passed away. The contestants who survived and achieved their target age will be paid the award amount; whereas, the contestants who did not survive until their target age will be paid nothing (FIG. 2).

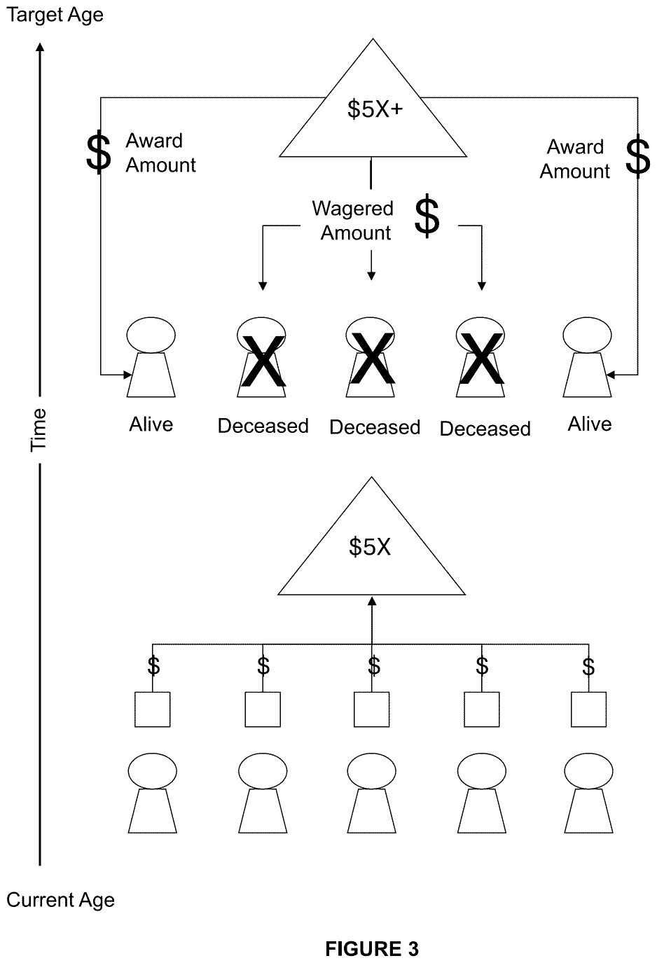

Referring to FIG. 3, in other alternative embodiments, the electronic game may be structured in a way that contestants who survive and achieve their target age will be paid the award amount; whereas, the contestants who do not survive until their target age will be paid and refunded the wagered amount (or, more specifically, the wagered amount will be paid and refunded to an estate or designee that was previously specified by each contestant who did not survive until their target age).

The invention provides that “surviving until a target age,” “reaching a target age,” “achieving a target age,” and other similar phrases used throughout this specification may be accorded different meanings within the electronic gaming systems. For example, the electronic gaming systems may define such endpoints in a particular game to require a contestant to simply be alive as of the target age. In other embodiments, the electronic gaming systems may define such endpoints in a particular game to not only require a contestant to be alive, but also fully conscious and mentally sound (e.g., requiring a licensed neurologist to certify that a contestant is fully conscious and is not exhibiting clinical symptoms of abnormal dementia; requiring the contestant to sign a designated claim form in the presence of a notary; and/or other suitable methods). In other cases, the electronic gaming systems may define such endpoints in a particular game to not only require a contestant to be alive and mentally sound, but also to satisfy other medical requirements (e.g., maximum weight or body mass requirements; certified by a physician not to be diagnosed with certain diseases; or other medical-related requirements established by the game operator). In all such embodiments, the endpoint that triggers the payment of the award amount to each contestant will be clearly communicated to and accepted by each contestant.

In certain embodiments, the invention provides that the award amount is influenced by the target age, an amount of time between the current age and target age, and the wagered amount. For example, the invention provides that as the target age increases, the potential award amount increases, insofar as a contestant's statistical chance of surviving until the target age decreases as such target age increases (thereby justifying a greater award amount). Likewise, the invention provides that as the span of time between a contestant's current age and the target age increases, the potential award amount will also increase. The invention provides that the gaming system may take into account other contestant-related data when computing the award amount. For example, the gaming system may factor into its computation a contestant's gender, nationality, geographic region, weight, height, exercise patterns, smoking and alcohol status, health and disease status, medical history, prescription drug use, net worth, parental health data, sibling health data, and other factors that influence a person's longevity. Such additional data may be collected from prospective contestants through the electronic user interface 18 that is operably connected to the gaming system. In other embodiments, certain of such information may also be accessed and collected from third party sources with a contestant's permission, such a contestant's electronic medical records and/or financial data stored within a third-party facility.

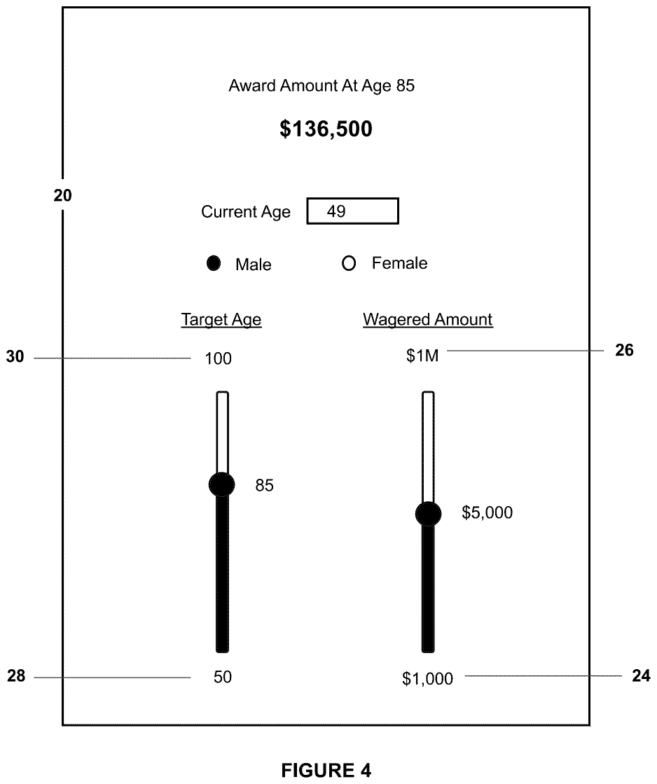

Referring now to FIG. 4, according to certain preferred embodiments, the gaming system will be configured to present within the electronic user interface 18 a calculator 20. The calculator 20 is preferably configured to enable a prospective contestant to specify a current age, target age, and wagered amount—and, preferably, allow the prospective contestant to actively modify such inputs to receive immediate feedback on the resulting potential award amount. The invention further provides that the system is also configured to present the award amount to each contestant (as illustrated in FIG. 4); receive each contestant's approval of the award amount and the related conditions of participation (e.g., through an electronical user agreement); and electronically collect funds from each contestant that represent the wagered amount (e.g., by collecting the wagered amount through credit/debit card processing or ACH bank wire transfers).

The invention provides that the award amount may be configured in various ways. For example, the award amount may be predetermined (e.g., established by the game organizer in advance), with each contestant's current age, target age, and possibly some of the other variables mentioned above then being used by the gaming system to calculate the amount of the wagered amount that each contestant must submit to participate in the game (with the wagered amount varying among contestants based on the applicable current age, target age, and other variables that apply to each such contestant). The invention provides that the award amount may be guaranteed; whereas, in other cases, the award amount may be a best estimate, with the actual award amount being defined as of the target age (but may vary from the original estimated award amount depending on multiple factors).

More specifically, when the award amount is initially estimated, but not established until the target age, the award amount may be wholly (or partially) dependent upon how investments of the wagered amounts (by the game organizer) performed over time. As mentioned further below, the invention provides that the game organizer may elect to invest aggregated wagered amounts in public or private investments, the success of which may influence the actual award amounts. Likewise, the actual award amount, when defined as of the target age, may be influenced by the number of contestants who survived until their target age (i.e., the percentage and number of contestants who “win” the award amount may influence the actual award amount as of each contestant's target age).

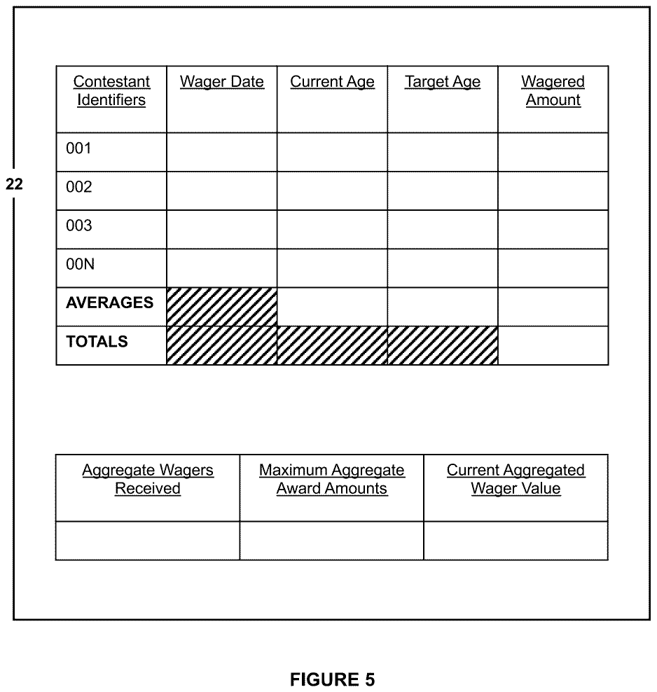

Referring now to FIG. 5, the invention provides that the electronic game system may further include a game management console 22 that only a game organizer may view, i.e., the contestants would not be allowed to access the game management console 22. The invention provides that the game management console 22 is preferably configured to generate electronic tables and reports that list contestant identifying information and each contestant's current age (the age at which a wager was submitted), target age, and the wagered amount. The invention provides that the game management console 22 is further configured to present aggregated balances of all wagered amounts and potential award amounts, which can be parsed based on target ages (and ranges of target ages) specified by the user of the game management console 22.

According to certain embodiments, the one or more processors 12 of the gaming system are further configured to implement a minimum wagered amount 24 and/or maximum wagered amount 26 that each contestant may submit (FIG. 4), with such minimum wagered amount 24 and/or maximum wagered amount 26 being defined by the game organizer within the game management console 22. Likewise, the one or more processors 12 of the gaming system may further be configured to implement a minimum target age 28 and/or maximum target age 30 that each contestant may submit, with such minimum target age 28 and/or maximum target age 30 being defined by the game organizer within the game management console 22.

The invention provides that the game organizer will aggregate wagered amounts and, optionally, invest all or a portion of the aggregated wager amounts. Such investments may be made into the public equity markets, private equity, fixed income instruments, real estate, cryptocurrency, and/or other forms of securities and investments. The invention provides that the game organizer will seek to grow the aggregated wager amounts over time, i.e., the period of times spanning from each contestant's current age and target age. This way, sufficient funds are available if and when target ages are achieved for some contestants and, furthermore, to provide a source of financial support and incentive for the game organizer.

Referring again to FIG. 5, the invention provides that the game management console 22 will preferably allow the game organizer to view the aggregated wager amounts received; the maximum/aggregate amount of award amounts that the gaming system must theoretically cover; and the then-current market value of all aggregated wager amounts invested by the game organizer, all of which may be parsed based on target ages (and ranges of target ages) specified by the user of the game management console 22. In other embodiments, the system may allow individual contestants to specify how their wagered amounts will be invested, with such decisions having direct implications on resulting award amounts.

### Trust Formation

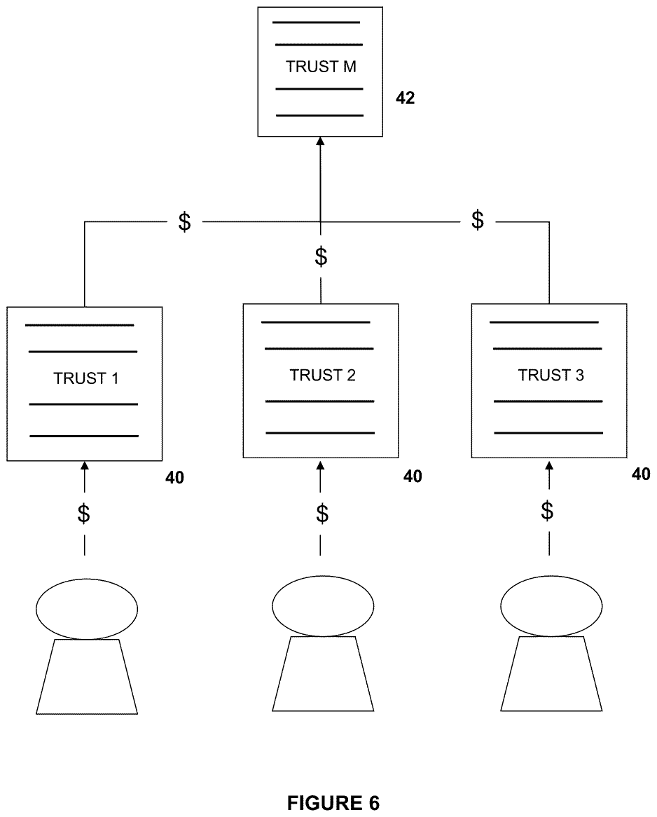

Referring now to FIGS. 6-11, according to certain embodiments, the present invention provides that the electronic gaming systems are preferably configured to carry out many of the functions described herein through a network of personal trust instruments. For example, the invention provides that when a contestant decides to participate in a game and submits his/her current age, target age, wagered amount, and other details described herein to the system, the system will utilize a trust instrument to codify—and serve as the legal conduit—for the conditions in which the gaming system will later pay the award amount to a particular contestant (FIG. 6). For example, in certain embodiments, the system will utilize an individual trust 40 for each participating contestant. Each individual trust 40 will be dedicated to a particular contestant.

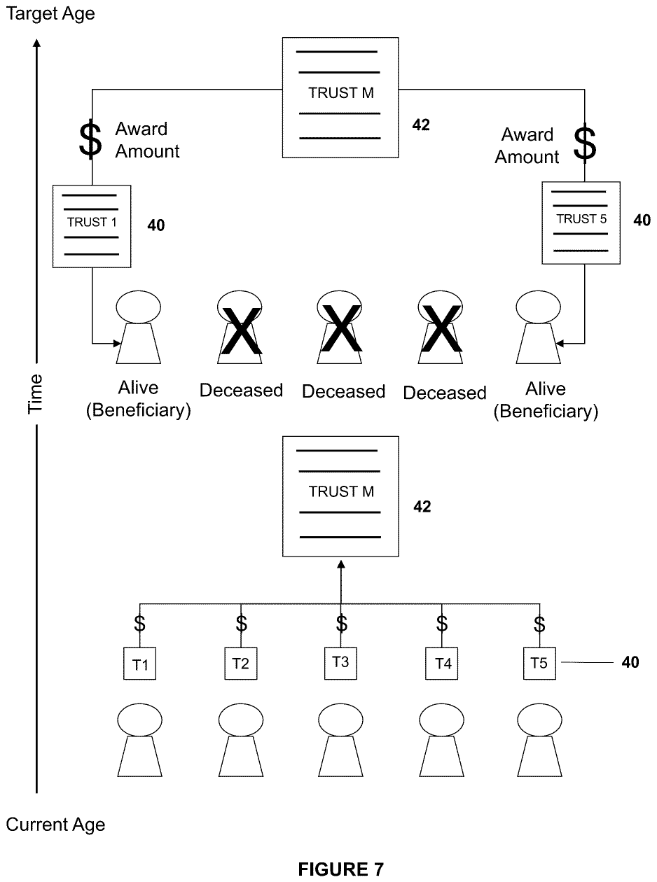

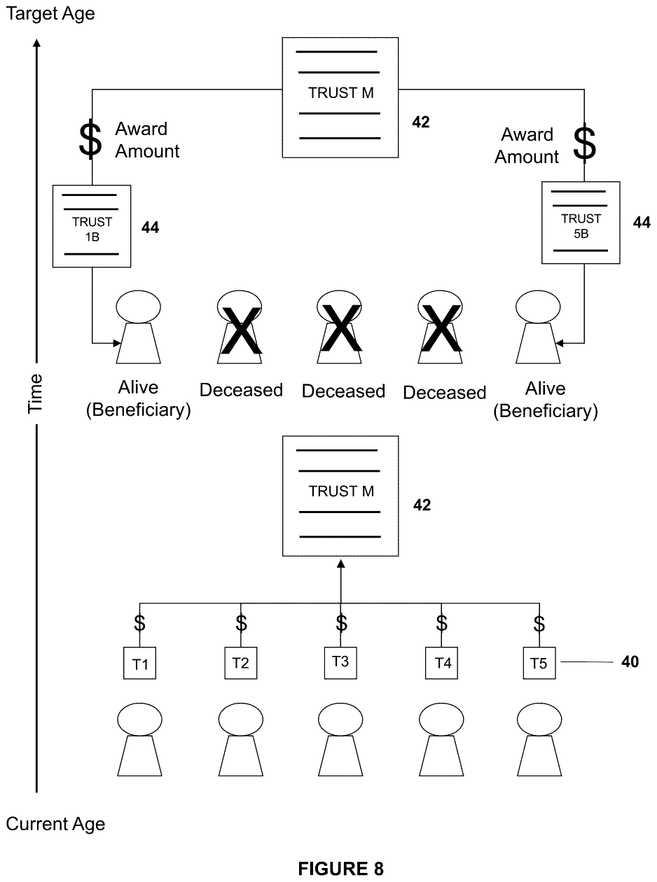

The invention further provides that, when a contestant registers to participate in a game, in addition to utilizing an individual trust 40 for each participating contestant, the system may also automatically generate and establish a master trust 42 instrument. The master trust 42 will be automatically linked to a plurality of individual trusts 40 for a series of contestants who are participating in the same electronic game. Such linkage may be in the form of an individual trust 40 naming a linked master trust 42 as the beneficiary. The individual trusts 40 that are dedicated to each contestant, along with the linked master trust 42, will include instructions and parameters that govern the conditions in which the award amount will be paid to a beneficiary (or multiple beneficiaries) identified in each such individual trust 40 and/or master trust 42. In certain cases, the funds may flow and be subject solely to an individual trust 40 and its associated master trust 42 (FIG. 7); whereas, in other examples, the funds may flow and be subject to an individual trust 40; its associated master trust 42; and a second individual trust 44 that is established and governs if a contestant survives until the target age for a game (FIG. 8).

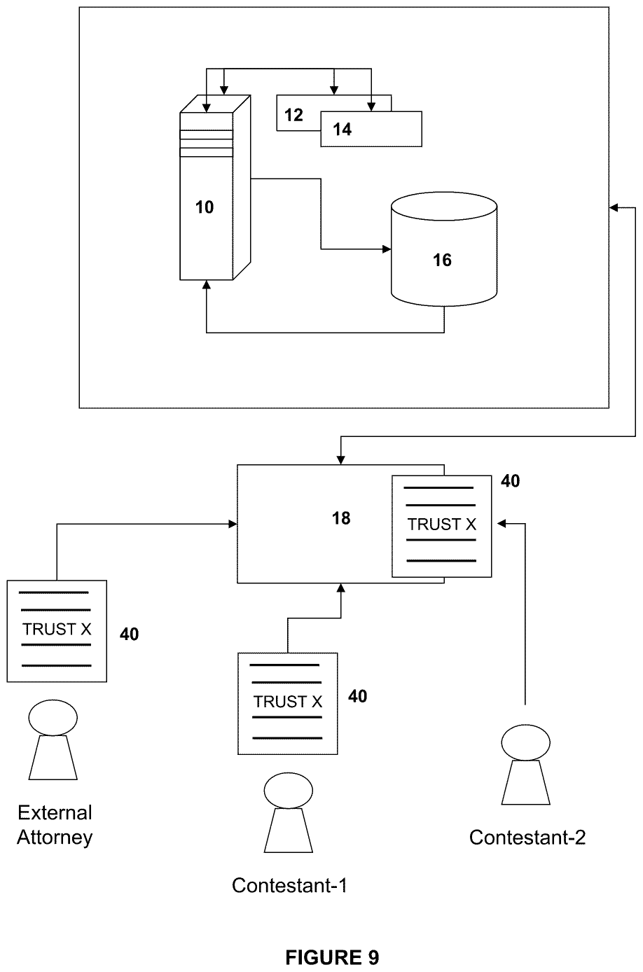

Referring now to FIG. 9, the invention provides that the system is configured to electronically receive and/or generate individual trusts 40 in various ways. For example, the invention provides that the individual trust 40 for each contestant may be created outside of the system—and then uploaded to the server 10 of the system by uploading such individual trust 40 to the server 10 through the electronic user interface 18 (e.g., such as from a contestant's attorney or directly from the contestant). Such access and ability to upload existing trust instruments for a particular contestant may be carried out through application programming interfaces (APIs). In other embodiments, the server 10 of the system is configured to generate each individual trust 40 for contestants by receiving input from each contestant through the electronic user interface 18 and, based on such input, automatically generate an individual trust 40 for each of such contestants within the system. In this latter example, the system may utilize artificial intelligence (AI) capability to formulate an individual trust 40, e.g., incorporating proposed details based on other similarly-situated contestants (i.e., contestants of similar age, demographic, economic status, etc.). Of course, the invention provides that the individual trust 40 may be provided to the system in any of those three different ways—uploading from an attorney or financial advisor; uploading directly from a contestant; and/or through the creation of the trust by the system itself.

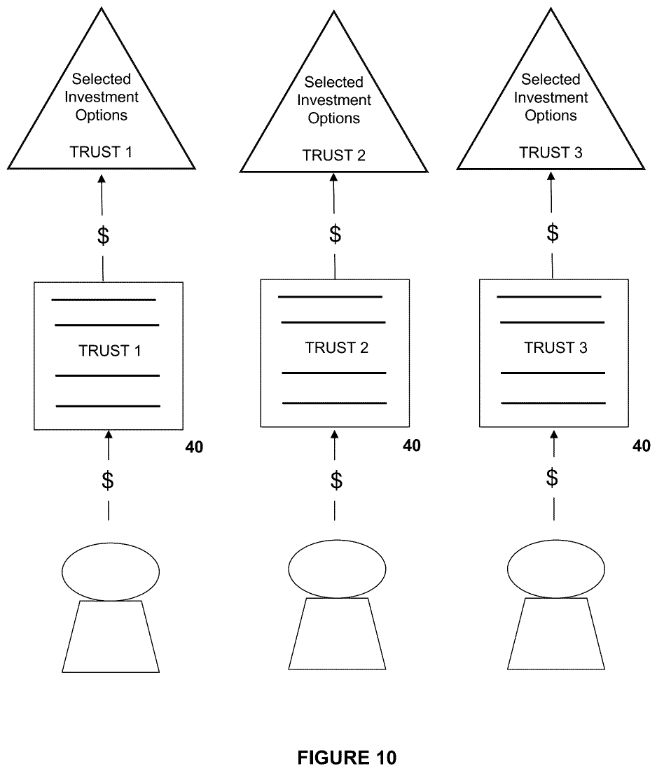

In addition to codifying the conditions in which an award amount is paid, such individual trusts 40 and master trusts 42 may be designed to allow contestants to submit preferences on how wagered amounts are handled by the system, such as by specifying how the wagered amounts are invested (FIG. 10). In some embodiments of the present invention, each contestant may specify how wagered amounts are invested over time (FIG. 10). For example, if a contestant wishes to assume a higher level of risk, and invest a wagered amount in securities that exhibit higher risk (but also potentially higher returns), the contestant may do so through elections within the system. Conversely, if a contestant wishes to minimize risk exposure, and invest a wagered amount in securities that exhibit a lower level of risk (but also potentially lower returns), the contestant may do so through elections within the system. The invention provides that such investment selections will likely impact the size of the potential award amount. In still further embodiments, the system may be configured to automatically make adjustments to invested wagered amounts if specified market conditions suggest the same to maximize returns. The invention provides that the investment status and amounts associated with a particular contestant can be accessed and monitored within the electronic user interface 18 of the system.

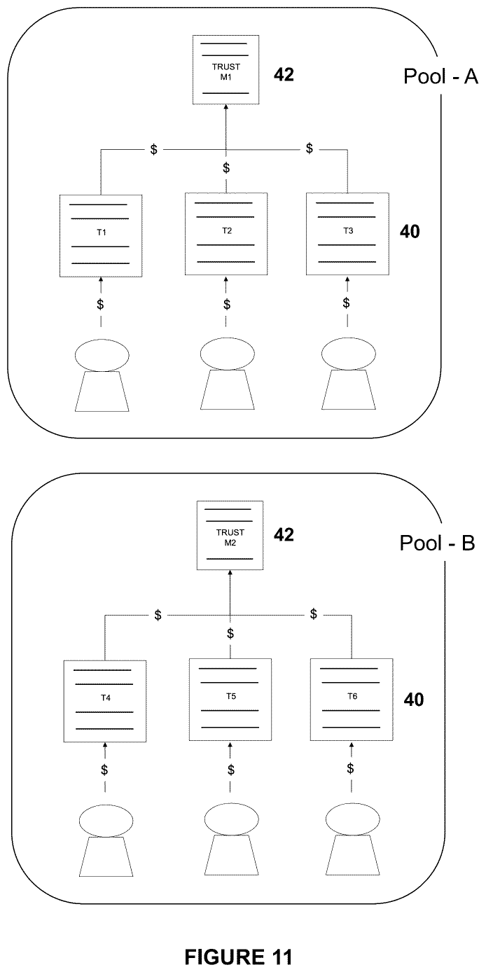

As mentioned above, according to such embodiments of the present invention, the system is configured to automatically generate a master trust 42 that is linked to each individual trust 40 that is dedicated to each contestant participating in a particular game. The invention provides that the master trust 42 also includes instructions that govern the conditions in which the award amount will be paid to the beneficiary (or multiple beneficiaries) identified in each such individual trust 40. Referring now to FIG. 11, in such embodiments, the system is preferably configured to automatically group contestants into separate pools, each of which are assigned to a particular master trust 42, with the contestants being grouped into a pool based on criteria specified by a game organizer (such as similarities in current ages, target ages, wagered amounts, award amounts, and other criteria).

For example, the system may be configured to group contestants who are the same current age; who have a current age that falls within a specified number of years of each other; who specify the same (or similar) target age; who submit a wagered amount within a predefined range; and/or any other criteria that can be used by the system to pool similarly-situated contestants, which may be assigned to and take part in a particular game (which is governed by a particular master trust 42). The pooling of such contestants may be carried out through AI methodologies. Still further, the invention provides that such pools may also, in whole or in part, be randomly formulated with contestants, to avoid inadvertent disclosure of contestants who are playing the same game and, e.g., subject to the same master trust 42, i.e., to avoid contestants easily assuming that persons with the same current age are subject to the same pool. Such feature may be important to maintain confidentiality among contestants and their associated pools.

In other embodiments, the electronic gaming system may be operated to generate master trusts 42 that involve gaming contestants who share other bonds (but may not otherwise share the same or similar current age, target age, etc.). For example, the invention provides that the system may be operated to carryout longevity games—and to generate corresponding master trusts 42—that involve pools of related family members (e.g., husband and wife), a pool of friends, a pool of church members, a pool of union members, and so forth. In these embodiments, the current ages and target ages of each member of the pool may be defined, but then blended in various ways such that the death and survival of each member of the pool will have an impact on the award amount to be paid into and distributed among the members of the pool; provided, however, that the outcome is not strictly a binary outcome dependent on a single member/contestant (e.g., in the case where an award amount is paid if, and only if, a single contestant survives until the target age). That is, such embodiments allow members of the pool to tailor the game in a way that a particular gaming contestant's (pool member's) early death before a target age does not completely extinguish the potential award amount that would be paid to other pool members/contestants.

Still further, in such embodiments, the system may generate master trusts 42 involving pools of contestants that overlap. For example, the system may generate a first master trust 42 for a pool of contestants within the same immediate family (e.g., husband and wife). In this example, if either of the contestants (husband or wife) survive until the defined target age, a portion of the award amount is paid to the designated beneficiaries of the first master trust 42, while another portion is transferred to a second master trust 42 involving extended family members (e.g., siblings, nieces, nephews, etc.). Accordingly, such embodiments allow contestants to potentially reward immediate family members if target age(s) are achieved and, optionally, other extended family members, organizations, or even large populations of contestants.

The invention provides that the system is configured to encrypt all contents of the individual trusts 40 and master trusts 42—and, furthermore, to heavily encrypt, disguise, and prevent disclosure of all contestant identifying information associated with such individual trusts 40 and master trusts 42. Likewise, the relationships and linkages among individual trusts 40 and master trusts 42 will be encrypted. The invention provides that the system will preferably employ multiple layers of encryption to the contents of such individual trusts 40 and master trusts 42, and all communications between contestants and the system. Multiple layers of encryption and the use of randomly-generated IDs will preferably be employed, such that external parties and employees of the game organizer are prevented from identifying contestants involved in a particular game.

### Longevity Games as Reinsurance Products

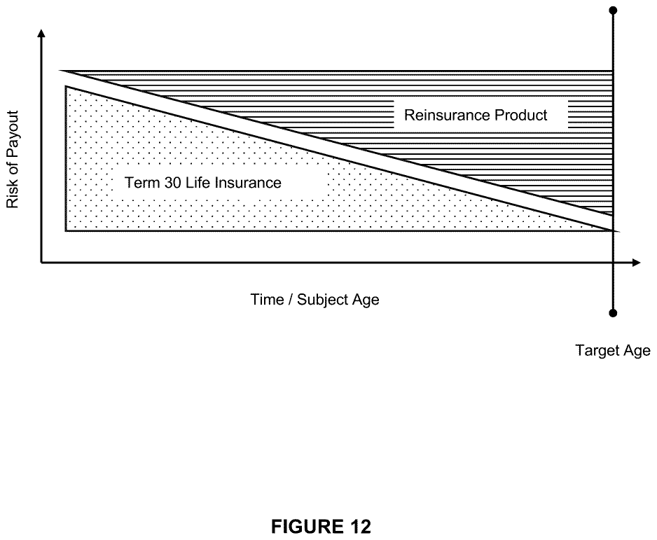

Referring now to FIGS. 12-16, according to certain preferred embodiments of the present invention, the electronic games of the present invention may be used and made a part of reinsurance products. More particularly, the invention further encompasses electronic games coupled to electronic systems for designing and issuing reinsurance products, particularly reinsurance products that apply to the life insurance industry. The reinsurance products described herein directly involve each insured subject's ability to live until a desirable age.

The invention provides that each insured subject may participate in the electronic gaming systems described herein as a gaming contestant. According to such embodiments, the invention provides that the processors 12 are configured to receive, calculate, and record within the database 16 a current age, a target age, a reinsurance premium, and a reinsurance amount corresponding to each contestant (insured subject) and each corresponding reinsurance product. The invention provides that, in certain optional features of the electronic gaming systems described herein, the systems may be configured to design and issue reinsurance products that are effective to mitigate the risk associated with the life insurance policies issued by a life insurance company. Referring to FIG. 12, for example, in the case of a term 30 life insurance policy, the risk that an insurance company will be obligated to pay out on a policy decreases over time as an insured subject gets closer to the 30-year end date of such policies. The relationship shown in FIG. 12 is for illustration purposes only, insofar as such risk of payout is not simply linear as shown therein since age-related factors do increase the chance of death over time and a person's lifespan. However, for the sake of illustration, the absolute quantum of risk of a life insurance policy having to issue a payout generally decreases over time as coverage approaches the expiration date (e.g., a 30-year, 20-year, or 15-year expiration date).

Conversely, the system of the present invention is configured to design and issue reinsurance products—as part of the longevity game played by insured contestants—that carry an increase in risk of payout as an insured subject approaches an agreed upon target date. Accordingly, as illustrated in FIG. 12, the reinsurance products designed and generated by the gaming systems described herein have risk profiles that essentially represent the inverse of the risk profiles of traditional term life insurance products. Thus, as described herein, the system of the present invention may be operated to not only provide longevity-related games to individual contestants, but also to design and issue reinsurance products that mitigate the risk of payouts stemming from traditional life insurance policies associated with such contestants.

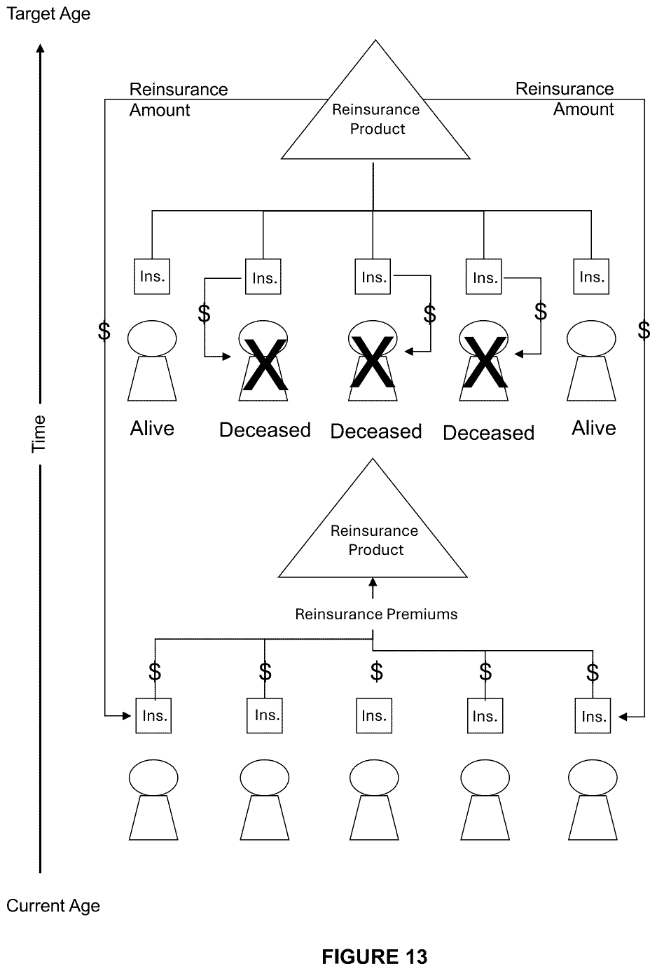

Referring now to FIG. 13, the reinsurance products issued by the system described herein are designed to pay the owner of such reinsurance products (i.e., a life insurance company) if, and only if, a particular insured subject (gaming contestant) survives until an agreed upon target age. The invention provides that the system may include a means for verifying the current age that is attributed to each insured subject. In these embodiments, the invention provides that an insured subject's “current age” may be defined and set as the age of the insured subject (gaming contestant) on the date on which an insurance company decides to reinsure against the risk of the insured subject (gaming contestant) passing away during an insured period (e.g., during the 30-year period of a term 30 life insurance policy). In such embodiments, the “target age” is preferably defined and set by the insurance company that is designing and purchasing the reinsurance product.

In such embodiments, as illustrated in FIG. 13, if the insured subject (gaming contestant) survives until the target age, the reinsurance product is then obligated to pay the insurance company the agreed upon reinsurance amount. The “reinsurance premiums” represent an amount of money that each insurance company agrees to pay the reinsurance company in exchange for the applicable reinsurance product. In such embodiments, the invention provides that each insured subject's identifying information, current age, target age, and (optionally) proposed reinsurance premium will be electronically transmitted to and from the system through an electronic user interface 18, whereupon the system automatically calculates a proposed reinsurance amount for the insurance company to consider.

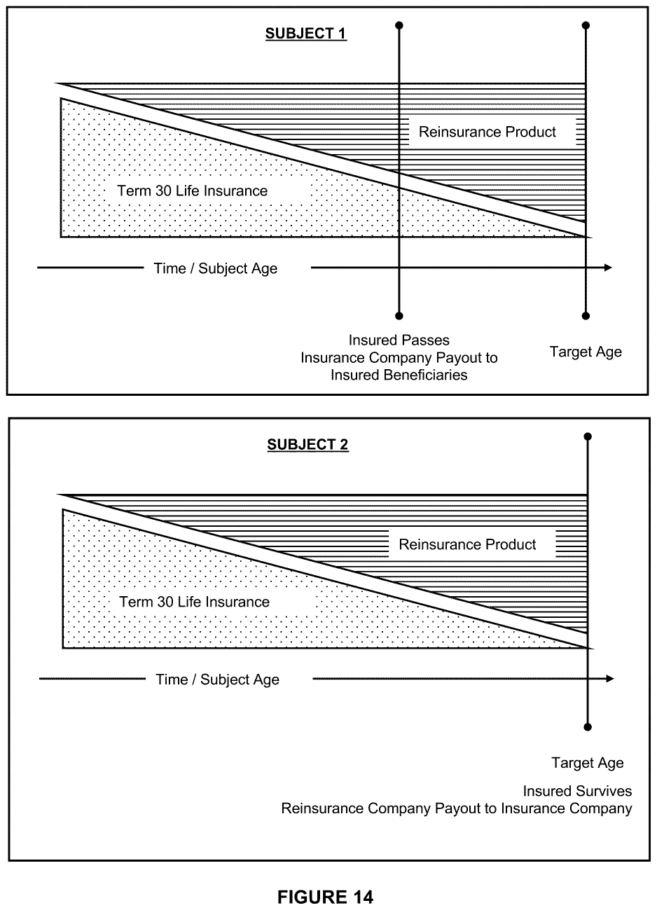

According to such preferred embodiments, as mentioned above, the system is further configured to calculate a reinsurance amount that the system requires to be paid to an insurance company if, and only if, the applicable insured subject (gaming contestant) lives until the target age. As illustrated in FIG. 13, for example, if five insured subjects are covered by an insurance company's life insurance policies, at the time of each insured subject's specified and agreed upon target age, some insured subjects will have survived and achieved their target age, while others will have passed away. The insured subjects (gaming contestants) who survived and achieved their target age will trigger a payment of the reinsurance amount from the reinsurance company to the applicable insurance company; whereas, the insured subjects who did not survive until their target age will be paid the agreed upon amount from their respective life insurance policies (or, more specifically, the beneficiaries of the deceased subjects will be paid the agreed upon amount from their respective life insurance policies). This relationship is also illustrated in FIG. 14. The invention provides that, in the case of a particular insured subject (gaming contestant), the agreed upon target date for a reinsurance product may be the same as, or different than, the expiration date of a life insurance policy that applies to the same insured subject (gaming contestant).

In certain embodiments, the invention provides that the reinsurance amount is influenced by the target age, an amount of time between the current age and target age, and the amount of the reinsurance premium-similar to the award amount described above. For example, the invention provides that as the target age increases, the potential reinsurance amount may increase, insofar as an insured subject's statistical chance of surviving until the target age decreases as such target age increases (thereby justifying a greater reinsurance amount). Likewise, the invention provides that as the span of time between an insured subject's current age and the target age increases, the potential reinsurance amount may also increase-again, similar to the award amount described above.

The invention provides that the systems of the present invention may take into account other subject-related data when computing the proposed reinsurance amount. For example, the system may factor into its computation an insured subject's gender, nationality, geographic region, weight, height, exercise patterns, smoking and alcohol status, health and disease status, medical history, prescription drug use, net worth, parental health data, sibling health data, and other factors that influence a person's longevity. Such additional data may be collected from insured subjects through the electronic user interface 18 that is operably connected to the system. In other embodiments, as mentioned above, certain of such information may also be accessed and collected from third party sources with an insured subject's permission, such as a subject's electronic medical records and/or financial data stored within a third-party facility.

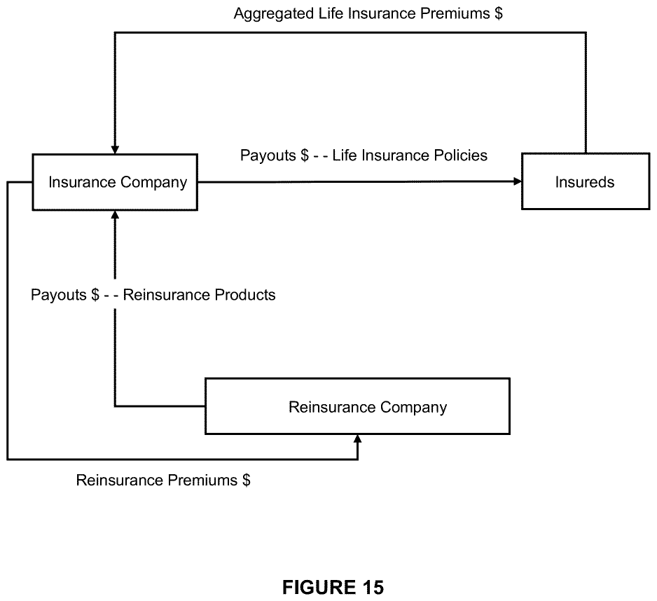

The invention provides that the system of the present invention may be accessed and operated by insurance companies to hedge and mitigate the aggregate risk of paying out life insurance awards. As illustrated in FIG. 15, such insurance companies may frequently assess the amount of life insurance premiums that they collect; the potential payouts stemming from such life insurance policies and the statistical probabilities of such payouts; the amount reinsurance premiums that life insurance companies are willing to pay; and the amount of potential reinsurance amounts that such companies should prudently seek to recover under specified circumstances. The insurance companies may utilize the systems described herein, along with actuarial science, to strike the desired balance between risk of aggregated life insurance payouts and the amount of potential reinsurance amounts that such companies may receive—all with the purpose of accepting and/or reinsuring against the aggregate payout risk that a life insurance company holds at any given time.

The invention further provides that the reinsurance amount may be configured in various ways. For example, the reinsurance amount may be predetermined (e.g., established by the system and/or reinsurance company in advance), with each insured subject's current age, target age, and possibly some of the other variables mentioned above then being used by the system to calculate the amount of the reinsurance premium that the insurance company must pay in exchange for the reinsurance product (with the reinsurance premium varying among insured subjects (gaming contestants) based on the applicable current age, target age, and other variables that apply to each such insured subject as described above). Similar to the other embodiments described above, the invention provides that the reinsurance amount may be guaranteed; whereas, in other cases, the reinsurance amount may be a best estimate, with the reinsurance amount being defined as of the target age (but may vary from the original estimated reinsurance amount depending on multiple factors).

More specifically, as explained above, when the reinsurance amount is initially estimated, but not established until the target age, the reinsurance amount may be wholly (or partially) dependent upon how investments of the reinsurance premiums (by the reinsurance company) performed over time. The invention provides that the reinsurance company may elect to invest aggregated reinsurance premiums in public or private investments, the success of which may influence the actual reinsurance amounts. Likewise, the actual reinsurance amount, when defined as of the target age, may be influenced by the number of insured subjects who survived until their target age (i.e., the percentage and number of insurance companies that are entitled to receive reinsurance amounts may influence the actual reinsurance amount as of each insured subject's target age).

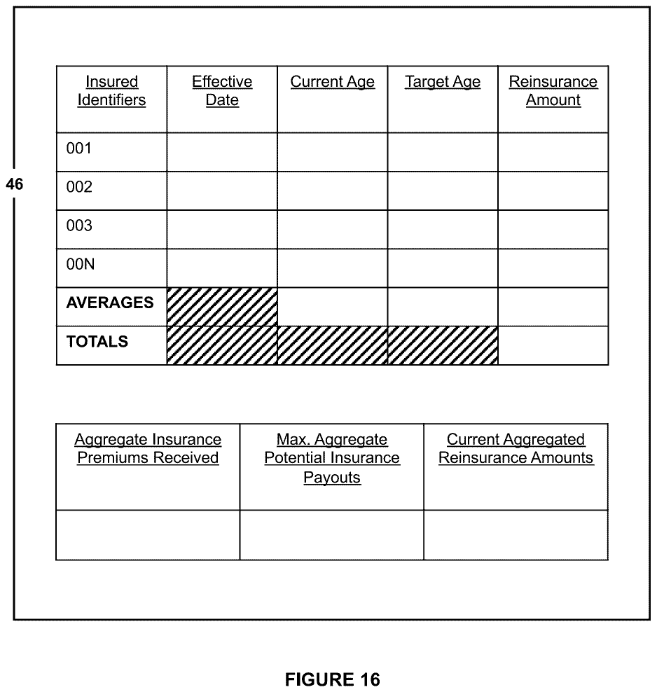

Referring now to FIG. 16, the invention provides that the electronic system may further include a reinsurance management console 46 that a particular insurance company may view. The invention provides that the reinsurance management console 46 is preferably configured to generate electronic tables and reports that list insured subject (gaming contestant) identifying information and each insured subject's current age (the age at which a reinsurance product was purchased), target age, the reinsurance premium, and the potential reinsurance amount. The invention provides that the reinsurance management console 46 is further configured to present aggregated balances of all potential life insurance payout amounts and reinsurance amounts, which can be parsed based on any of numerous variables, such as target ages (and ranges of target ages) specified by the user of the reinsurance management console 46.

The invention provides that the reinsurance company may aggregate the reinsurance premiums that it receives and, optionally, invest all or a portion of such reinsurance premiums. Such investments may be made into the public equity markets, private equity, fixed income instruments, real estate, cryptocurrency, and/or other forms of securities and investments. The invention provides that the reinsurance company will seek to grow the aggregated reinsurance premiums over time. This way, sufficient funds are available if and when target ages are achieved for some insured subjects. Referring again to FIG. 16, the invention provides that the reinsurance management console 46 will further allow a reinsurance company to view the aggregated reinsurance premiums received; the maximum/aggregate amount of reinsurance amounts that the system must theoretically cover; and the then-current market value of all aggregated reinsurance premiums invested by the reinsurance company, all of which may be parsed based on client-insurance companies, target ages (and ranges of target ages), and/or other criteria.

### Allocation of Wagered Amounts

As mentioned above, the invention provides that a contestant's wagered amount may be automatically invested by the system in various ways. For example, once a contestant enters a longevity game described herein, all or a defined portion of the wagered amount may be invested into the public markets, e.g., the wagered amounts could be invested into an S&P Index fund. The current value of such invested wagered amounts may be tracked and viewed within the game management counsel 22 described above—and, furthermore, could optionally be accessible to each contestant of a particular game within a contestant-only dedicated portion of the game management counsel 22. In certain preferred embodiments, as mentioned above, the wagered amounts may be invested in such manner through one or more individual trusts 40 and/or master trust 42 instruments.

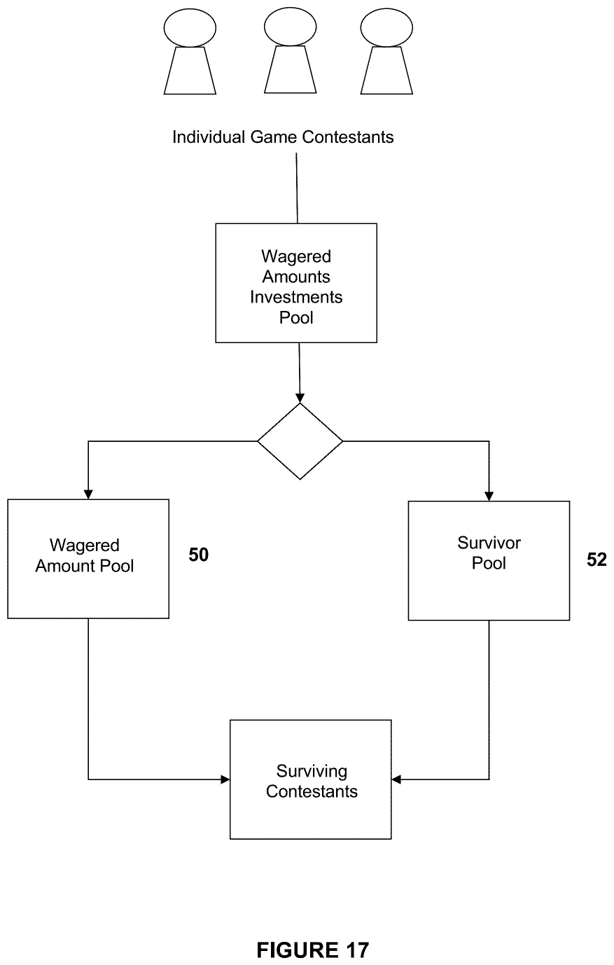

Referring now to FIG. 17, the invention provides that a portion of the invested wagered amount pool 50 may be periodically (e.g., monthly, annually, etc.) transferred to a separate fund that is dedicated to survivors, i.e., a so-called survivor pool 52. In certain embodiments, the invention provides that the amount held within the invested wagered amount pool 50 is preferably sufficient to pay the wagered amounts back to each contestant of a particular game who survives until the defined target age, taking into account the predicted performance of the applicable investments over time and the probability-adjusted number of predicted target age survivors. The invention provides that the system may be configured to optionally and periodically charge and deduct a management fee (e.g., 1-2%) from the invested wagered amount pool 50 and/or survivor pool 52. The wagered amount pool 50 and survivor pool 52 may consist of separate financial accounts—or, alternatively, the funds for both the wagered amount pool 50 and survivor pool 52 may be held within the same financial account but tracked and accounted for separately from an accounting perspective.

In certain embodiments, the invention provides that for known or expected deaths of contestants, a corresponding amount of funds associated with such contestants may be transferred from the wagered amount pool 50 to the survivor pool 52. The survivor pool 52 is preferably configured to estimate the aggregate funds to be forfeited by contestants who do not survive until their target ages. As such, the survivor pool 52 is designed to enhance the potential award amount paid to those contestants who achieve their target ages. In certain embodiments, an amount may be transferred from the wagered amount pool 50 to the survivor pool 52 based on each contestant's probability of surviving until the target age, i.e., for each contestant in a game, the product of the then-current invested wagered amount and the statistical probability of each such contestant surviving until his/her target age may be transferred to the survivor pool 52 on a periodic basis. As described above, the statistical probability of each contestant surviving until his/her target age may take into account the age of each contestant at the time he/she enters a game; the amount of time that must pass to reach the target age; the target age itself (e.g., a 90-year target age will be statistically less likely to be achieved than a 60-year target age, for a person who enters the game at age 50); the contestant's gender; the geographical region(s) in which the contestant lives (or has lived for a period of time); and other variables. In other embodiments, the invention provides that funds associated with only contestants who are known to have passed—and who are known to not have survived until their target age—will be transferred from the wagered amount pool 50 to the survivor pool 52.

In certain preferred embodiments, in the event that a contestant survives until his/her target age, such that the contestant is entitled to an award amount, the system may be configured to pay the successful contestant the then-current value of the invested wagered amount from the wagered amount pool 50 (less administrative fees), along with a defined portion taken from the survivor pool 52. More particularly, each surviving contestant will receive (1) the then-current value of the invested wagered amount from the wagered amount pool 50 (less any administrative fee) plus (2) a defined portion taken from the survivor pool 52 (less any administrative fee). Of course, sufficient funds should remain within the survivor pool 52 for potential payouts to other successful contestants who achieve their target ages.

In certain embodiments, the amount that is transferred from the wagered amount pool 50 to the survivor pool 52 for a particular contestant may represent the sum of the contestant's pre-target age death probability multiplied by the then-current value of the contestant's wagered amount as invested within the wagered amount pool 50 over the duration of the game. The invention provides that if such contestant survives until his/her target age, the amount returned to such contestant may include a share of the survivor pool 52 that represents a ratio of (i) the contestant's own survivor pool 52 contributions to (ii) all other contestant contributions to the survivor pool 52. According to such embodiments, a contestant's expected survivor pool 52 contribution—which may be calculated and transferred on an annual basis—may be calculated as follows:

$$Current Year Expected Survivor Pool 52 Contribution = Death Probability ( Current Wagered Amount Pool 50 Value - Σ ( Prior Year Contributions ) )$$

In such embodiments, the total/aggregated amount of a particular contestant's expected contributions to the survivor pool 52 over the duration of the game will be the sum of each year's then-current value of the contestant's invested contribution to the wagered amount pool 50 multiplied by such contestant's probability of dying that year. Still further, in such embodiments, each contestant's expected award amount at his/her target age may be calculated as the amount of the total survivor pool 52 for a particular game multiplied by the surviving contestant's total contributions to the survivor pool 52, divided by the sum of all total expected survivor pool 52 contributions from all contestants for a particular game as of such target age. This calculation is represented by the formula below:

$$Contestant Survivor Pool 52 Allocation = Survivor Pool 52 Total * ( Contestant ’ s Total Survivor Pool 52 Contribution / {\sum }_{1}^{n} ( Contestant n ’ s Total Survivor Contributions ) )$$

The invention provides that the longevity games described herein can also be used to modify how a contestant's own retirement savings are utilized. For example, for purposes of illustration, some retirement strategies have retirees planning to use roughly 50% of their own savings up until the point of average life expectancy (e.g., about 80 years of age for U.S. males), with the remaining 50% being reserved for life beyond that date (e.g., until about 95 years of age). Thus, roughly have of those retirees—who do not survive past the average life expectancy—unnecessarily do not spend and enjoy about half of their retirement savings. For those retirees who participate in the longevity games described herein, the retirees/contestants could safely accelerate their spending of retirement savings up until the defined target age for the applicable game. This way, if they pass away prior to the target age, they will have safely maximized the spend and enjoyment of their own retirement savings, while those who do survive past the target age will receive the award amount and returns from their own wagered amount (such that depleting their own retirement savings at that point will not carry a negative consequence on their quality of life).

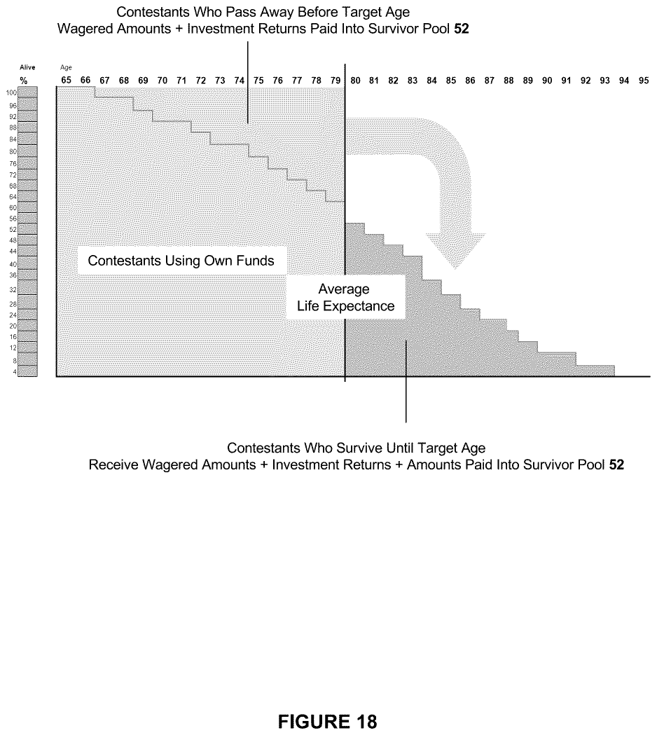

To further illustrate, and referring now to FIG. 18, a contestant who participates in a longevity game may plan to draw down and enjoy a majority of his/her retirement savings up to the defined target age. In the example shown in FIG. 18, the target age is set at the average life expectancy for U.S. males. The contestant's wagered amount will be invested within the wagered amount pool 50 as described above. For other contestants in the same game who do not survive until the target age, their wagered amounts and associated investment returns will be transferred into the survivor pool 52, as described above. Thus, for the contestants who do survive until the target age, and who therefore had the freedom to draw down a majority of their own retirement savings up to the target age, they will be awarded a portion of their own wagered amounts, plus a portion of the investment returns from the wagered amounts, and plus a percentage of the amounts transferred into the survivor pool 52 from contestants who did not live until their target ages. In these embodiments, the invention provides that each contestant within a longevity game may have a different starting age and a different target age; however, the formula for the award amount will remain the same for each such contestant, as summarized below.

$$[ Wagered Amount ] \times [ Investment Return Multiple for Wagered Amount ] \times [ Survivor Pool Return Multiple ] = [ Survivor Pool Award Amount ]$$

### AgeTech Platform

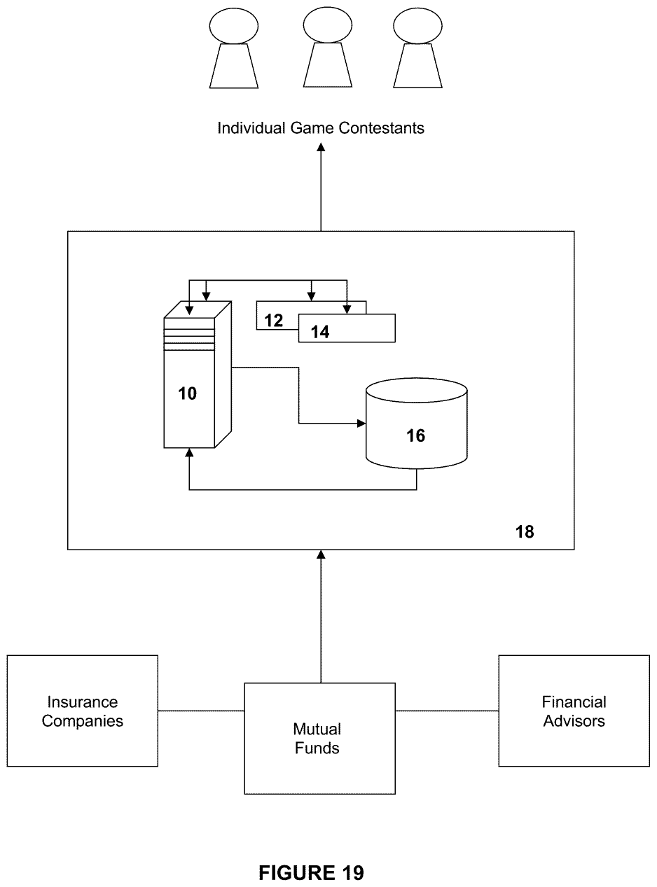

Referring now to FIG. 19, according to yet further embodiments, the present invention encompasses a comprehensive “AgeTech” platform, which may be accessed, operated, and utilized by the gaming contestants described herein, along with gaming companies (such as casinos wanting to create simple longevity-related games of chance), insurance companies (e.g., to generate the reinsurance products described herein), wealth and financial advisors, mutual funds, and others. In other words, the electronic gaming systems of the present invention may serve as a centralized hub through which individuals may participate in the longevity-related games described herein; insurance companies may generate reinsurance products that apply to such contestants (and/or pools of contestants); financial advisors may create Regulation A compliant (SEC exempt) trusts described herein that become a part of each contestant's long-term financial planning; mutual funds may create packages of bundled master trusts 42 that operate, in part, as SEC-compliant mutual funds (e.g., the pool of gaming contestants and corresponding trusts described above); etc. Indeed, the invention provides that the gaming system can be tailored and operated by each of those types of users, to achieve each user's specific goals.

According to additional aspects of the present invention, methods for establishing, organizing, deploying, and managing electronic gaming systems in the field of longevity are provided, which generally entail the operation of the systems described herein. Likewise, the invention further encompasses methods for generating trusts and master trusts that become an integral part of the longevity games described herein and, furthermore, methods for generating the reinsurance products and mutual funds described herein—all of which generally entail the operation of the systems described herein.

The many aspects and benefits of the invention are apparent from the detailed description, and thus, it is intended for the following claims to cover all such aspects and benefits of the invention that fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

We claim:

1. An electronic gaming system, comprising a server, one or more processors coupled to memory and a database, the one or more processors configured to:
(a) receive, and record within the database, contestant identifying information for each contestant;
(b) receive and record within the database each contestant's current age, target age, and a wagered amount;
(c) calculate an award amount that the gaming system will pay to each contestant if, and only if, each such contestant lives until the target age, wherein the award amount is influenced by the target age, an amount of time between the current age and target age, and the wagered amount; and
(d) present the award amount to each contestant; receive each contestant's approval of the award amount; and collect funds from each contestant that represent the wagered amount.

2. The electronic gaming system of claim 1, wherein the processor is further configured to authenticate an identity of each contestant based on each contestant's identifying information, wherein a means by which the identity is authenticated may comprise one or more steps that involve automated analysis of a government ID, notary verifications, and/or analysis of biometric data.

3. The electronic gaming system of claim 1, which further comprises a game management console that only a game organizer may view, which is configured to generate electronic tables that list contestant identifying information and each contestant's current age, target age, and wagered amount.

4. The electronic gaming system of claim 3, wherein the game management console is further configured to present aggregated balances of all wagered amounts and potential award amounts.

5. The electronic gaming system of claim 4, wherein the one or more processors are further configured to implement a minimum and/or maximum wagered amount that each contestant may submit, wherein such minimum and/or maximum wagered amount is defined within the game management console.

6. The electronic gaming system of claim 4, wherein the one or more processors are further configured to implement a minimum and/or maximum target age that each contestant may submit, wherein such minimum and/or maximum target age is defined within the game management console.

7. An electronic gaming system, comprising a server, one or more processors coupled to memory and a database, the one or more processors configured to:
(a) receive, and record within the database, contestant identifying information for each contestant;
(b) receive and record within the database each contestant's current age, target age, and a wagered amount;
(c) calculate an award amount that the gaming system will pay to each contestant if, and only if, each such contestant lives until the target age, wherein the award amount is influenced by the target age, an amount of time between the current age and target age, and the wagered amount;
(d) present the award amount to each contestant within an electronic user interface; receive each contestant's approval of the award amount; and collect funds from each contestant that represent the wagered amount; and
(e) generate and/or receive an individual trust that is dedicated to each contestant, wherein the individual trust includes instructions that govern conditions in which the award amount will be paid to a beneficiary identified in each such individual trust.

8. The electronic gaming system of claim 7, wherein the system is configured to receive the individual trust for each contestant by uploading such individual trust to the server through the electronic user interface.

9. The electronic gaming system of claim 7, wherein the server of the system is configured to generate each individual trust for contestants by receiving input from each contestant through the electronic user interface and, based on such input, automatically generating each individual trust for each of such contestants within the system.

10. The electronic gaming system of claim 7, wherein the system is configured to automatically generate a master trust that is linked to each individual trust that is dedicated to each contestant participating in a game, wherein the master trust includes instructions that govern conditions in which the award amount will be paid to the beneficiary identified in each such individual trust.

11. The electronic gaming system of claim 7, wherein the system is configured to:
(a) automatically generate a master trust that is linked to each individual trust that is dedicated to each contestant participating in a game, wherein the master trust includes instructions that govern conditions in which the award amount will be paid to the beneficiary identified in each such individual trust; and
(b) automatically group contestants into a pool that is assigned to the master trust, wherein the contestants are grouped into the pool based on criteria specified by a game organizer.

12. The electronic gaming system of claim 7, wherein the system is configured to encrypt contents of all individual trusts and master trusts.

13. The electronic gaming system of claim 7, wherein the system is configured to:
(a) encrypt contents of all individual trusts and master trusts; and
(b) disguise and prevent disclosure of all contestant identifying information associated with such individual trusts and master trusts.

14. An electronic system for designing and issuing reinsurance products, which comprises a server, one or more processors coupled to memory and a database, the one or more processors configured to:
(a) receive, and record within the database, insured subject identifying information for each of a plurality of insured subjects;
(b) receive and record within the database each insured subject's current age, target age, and a reinsurance premium corresponding to each insured subject;
(c) calculate a reinsurance amount that the system will pay to an insurance company if, and only if, each such insured subject survives until the target age, wherein the reinsurance amount is influenced by the target age, an amount of time between the current age and target age, and the reinsurance premium; and
(d) present the reinsurance amount to a representative of the insurance company; receive each such representative's approval of the reinsurance amount; and collect funds from each insurance company that represents the reinsurance premium.

15. The electronic system of claim 14, wherein the processor is further configured to authenticate an identity of each insured subject based on each insured subject's identifying information.

16. The electronic system of claim 14, which further comprises a reinsurance management console that an insurance company may access, which is configured to generate electronic tables that list each insured subject's identifying information and each insured subject's current age, target age, and reinsurance amount.

17. The electronic system of claim 16, wherein the reinsurance management console is further configured to present aggregated balances of all reinsurance amounts.

18. A centralized electronic hub through which a user may participate in the electronic gaming system of claim 1.

19. A centralized electronic hub through which a user may participate in the electronic gaming system, and generate the individual trust, of claim 7.

20. A centralized electronic hub through which a user may participate in the electronic gaming system, and generate the reinsurance products, of claim 14.
